(19) United States
(12) Patent Application Publication
(10) Pub. No.: US 2025/0298539 A1
(43) Pub. Date: Sep. 25, 2025

(54) CONTROLLER, HOST, AND COMMUNICATION METHOD

(71) Applicant: Kioxia Corporation, Tokyo (JP)

(72) Inventors: Yoshihiro OHBA, Kawasaki (JP); Takeshi ISHIHARA, Yokohama (JP); Tatsuro HITOMI, Yokohama (JP)

(73) Assignee: Kioxia Corporation, Tokyo (JP)

(21) Appl. No.: 19/074,577

(22) Filed: Mar. 10, 2025

(30) Foreign Application Priority Data
Mar. 21, 2024 (JP) 2024-044919

(51) Int. Cl. G06F 3/06

(52) U.S. Cl. CPC G06F 3/0655; G06F 3/0604; G06F 3/0679

(57) ABSTRACT

According to one embodiment, a controller includes a connection unit configured to receive first data and I/O command, and transmit second data, which is a result of calculation processing of the first data, and I/O command, a virtual register table configured to store a virtual register number that accompanies the first data and is identified based on the calculation processing, in association with a virtual address of third data and a data size of the third data, a calculation processor configured to execute the calculation processing by referring to the virtual register table, and a relay table configured to store pairs of source information and destination information.

### CROSS-REFERENCE TO RELATED APPLICATIONS

This application is based upon and claims the benefit of priority from Japanese Patent Application No. 2024-044919, filed Mar. 21, 2024, the entire contents of which are incorporated herein by reference.

### FIELD

Embodiments described herein relate generally to a controller, a host, and a communication method.

### BACKGROUND

The NVMe-oF™ standard (Non-Volatile Memory express over Fabric) is a standard that represents the implementation of a message-based transport model (message-only transport model or message/memory-based transport model) in the NVMe™ standard. There are two types of NVMe transport protocols used in the NVMe-OF standard: Remote Direct Memory Access (RDMA) and Transmission Control Protocol (TCP).

In an NVMe transport model, messages are defined in units of information called “capsule”. Capsule includes two types: a command capsule used for a command, and a response capsule used for a response. The command capsule includes a Submission Queue Entry field and a Data field. In a case where no data accompanies the command, the Data field of the command capsule is omitted. The response capsule includes a Completion Queue Entry field and the Data field. In a case where no data accompanies the response, the Data field of the response capsule is omitted.

NVMe transport protocol is a protocol for direct communication between a host and a storage device. The NVMe transport protocol cannot control indirect communication via a node that relays (referred to as “relay”) a message between the host and the storage device.

### BRIEF DESCRIPTION OF THE DRAWINGS

FIG. 1 illustrates an example of a storage system according to a first embodiment.

FIG. 2 illustrates an example of a virtual register table according to the first embodiment.

FIG. 3 illustrates an example of indirect communication between a host and a storage device according to the first embodiment.

FIG. 4 illustrates an example of a relay table according to the first embodiment.

FIG. 5 is a flowchart that explains an example of relay processing of an accelerator in a host according to the first embodiment.

FIG. 6 is a flowchart illustrating an example of relay processing of an accelerator in a node or a storage device according to the first embodiment.

FIG. 7 is a flowchart illustrating an example of relay processing of an accelerator in a node or a storage device according to the first embodiment.

FIG. 8 illustrates an example of a secret calculation instruction according to the first embodiment.

FIG. 9 illustrates an example of a virtual register number according to the first embodiment.

FIG. 10 illustrates an example of a host according to the second embodiment.

FIG. 11 illustrates an example of indirect communication between a host and a storage device according to the second embodiment.

FIG. 12 illustrates an example of indirect communication between a host and a storage device according to the third embodiment.

FIG. 13 illustrates an example of a relay table according to the third embodiment.

FIG. 14 illustrates an example of a host according to the fourth embodiment.

FIG. 15 illustrates an example of a node according to the fourth embodiment.

FIG. 16 illustrates an example of a network according to the fourth embodiment.

FIG. 17 illustrates an example of a network according to the fifth embodiment.

### DETAILED DESCRIPTION

Embodiments will be described below with reference to the drawings. In the following descriptions, a device and a method are illustrated to embody the technical concept of the embodiments. The technical concept is not limited to the configuration, shape, arrangement, material or the like of the structural elements described below. Modifications that could easily be conceived by a person with ordinary skill in the art are naturally included in the scope of the disclosure. To make the descriptions clearer, the drawings may schematically show the size, thickness, planer dimension, shape, and the like of each element differently from those in the actual aspect. The drawings may include elements that differ in dimension and ratio. Elements corresponding to each other are denoted by the same reference numeral and their overlapping descriptions may be omitted. Some elements may be denoted by different names, and these names are merely an example. It should not be denied that one element is denoted by different names. Note that “connection” means that one element is connected to another element via still another element as well as that one element is directly connected to another element. If the number of elements is not specified as plural, the elements may be singular or plural.

In general, according to one embodiment, a controller includes a connection unit, a memory, a virtual register table, a memory management unit, and a calculation processor.

The connection unit is connectable to a first node and a second node using NVMe transport protocol. The connection unit is configured to receive first data and an I/O command from the first node, and transmit second data, which is a result of calculation processing with respect to the first data, and the I/O command to the second node.

The memory is configured to store the first data.

The virtual register table is configured to store a virtual register number that accompanies the first data and is identified based on a calculation option that represents the calculation processing, in association with a virtual address of third data and a data size of the third data that are used to process a calculation instruction according to the calculation option.

The memory management unit is configured to write the first data to the memory and update the virtual register table.

The calculation processor is configured to execute the calculation processing with respect to the first data by referring to the virtual register table.

### First Embodiment

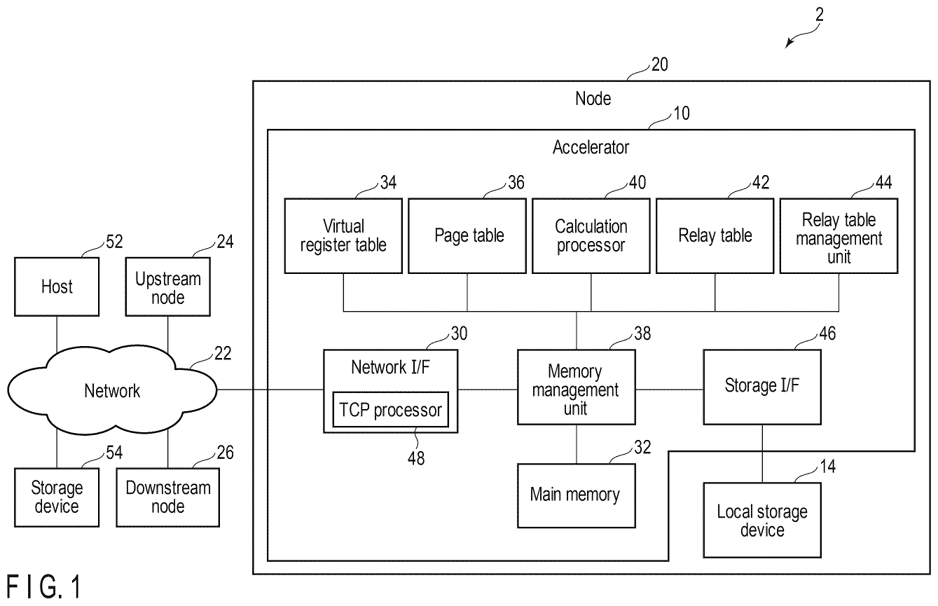

FIG. 1 illustrates an example of a storage system 2 according to a first embodiment. The storage system 2 includes a host 52, a storage device 54, an upstream node 24, a node 20, a downstream node 26, and a network 22. The storage system 2 is also referred to as an information processing system.

The storage device 54 includes a storage medium and a storage controller. An example of the storage medium is a NAND flash memory. The storage device 54 may be a solid state drive (SSD). The host 52 is an information processing device serving as an external device that accesses the storage device 54. The node 20 is a device that achieves indirect communication between the host 52 and the storage device 54. The node 20 comprises an accelerator 10. The accelerator 10 operates to improve the processing speed of the host 52. The accelerator 10 is also referred to as a controller.

The accelerator 10 comprises a network interface (network I/F) 30, a main memory 32, a virtual register table 34, a page table 36, a memory management unit 38, a calculation processor 40, a relay table 42, a relay table management unit 44, and a storage interface (storage I/F) 46. The node 20 may comprise a local storage device 14 and the storage I/F 46.

The node 20 is connected to the upstream node 24 and the downstream node 26 via the network 22. The upstream node 24 includes at least one node 20. In a case where the upstream node 24 includes a plurality of nodes 20, the plurality of nodes 20 are connected via the network 22. The node 20 may be connected to the host 52 via the network 22. The host 52 comprises at least the relay table 42, the relay table management unit 44, and the network I/F 30 among the components of the accelerator 10.

The downstream node 26 includes at least one node 20. In a case where the downstream node 26 includes a plurality of nodes 20, the plurality of nodes 20 are connected via the network 22. The node 20 may be connected to the storage device 54 via the network 22. The storage device 54 comprises at least a storage medium, the relay table 42, the relay table management unit 44, and the network I/F 30 among the components of the accelerator 10. The storage medium of the storage device 54 may realize the function of the local storage device 14.

The host 52 transmits a computing storage input/output (I/O) command (hereinafter referred to as an I/O command) to the upstream node 24, the node 20, or the storage device 54. The command is accompanied by host data. The host data is accompanied by metadata. In a case where the application of the host 52 causes the upstream node 24, the node 20, or the storage device 54 to perform calculation processing of the host data, it includes calculation options in the metadata. The calculation options represent a result of the calculation processing of the host data by the upstream node 24, the node 20, or the storage device 54. The accelerator 10 performs calculation processing on the host data according to the calculation options and replaces the host data with the processing result (calculation result).

The network I/F 30 receives an I/O command from the host 52, the upstream node 24, or the downstream node 26. The I/O command includes a read command for reading host data from the storage device 54 and a write command for writing host data to the storage device 54. The host data accompanying the I/O command (read command) includes read data that is read from the storage device 54 based on the I/O command. The host data accompanying the I/O command (write command) includes write data that is written to the storage device 54 based on the I/O command. The host data accompanying the I/O command is designated by a logical address used to access the storage device 54 (read data from the storage device 54 and write data to the storage device 54).

In a case where the host data is read data, the network I/F 30 receives the read data from the storage device 54, the upstream node 24, or the downstream node 26. In a case where the host data is write data, the network I/F 30 transmits the write data to the storage device 54, the upstream node 24, or the downstream node 26.

The network I/F 30 comprises a TCP processor 48. The TCP processor 48 attaches a TCP/IP header (described below) to a capsule to be transmitted to the network 22.

The main memory 32 stores host data (including read data and write data) accompanying the I/O command. The main memory 32 can be accessed at a higher speed than the local storage device 14. The main memory 32 may be realized by a volatile memory such as DRAM (not shown) provided in the node 20.

Data used to process a calculation instruction according to the calculation option in the metadata accompanying the host data accompanying the I/O command is stored in a virtual register. The virtual register table 34 is a table for managing the virtual register. The virtual register table 34 is stored in the nonvolatile memory provided in the node 20.

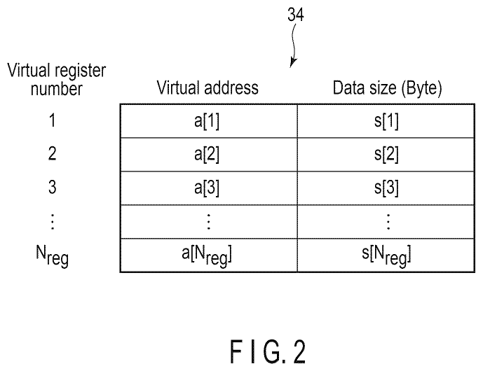

FIG. 2 illustrates an example of the virtual register table 34 according to the first embodiment. The data structure of the virtual register table 34 (the virtual registers managed in the virtual register table 34) is explained.

The virtual register table 34 comprises virtual register numbers 1 to N_{reg}, virtual addresses a[1] to a[N_{reg}], and data sizes s[1] to s[N_{reg}]. The virtual register numbers 1 to N_{reg} are specified (calculated) based on the calculation option. The virtual addresses a[1] to a[N_{reg}] are represented by a page number and a page offset assigned to a page where the data used to process a calculation instruction according to a calculation option is stored. The data sizes s[1] to s[N_{reg}] are in bytes. Details of the virtual register numbers 1 to N_{reg}, which are specified based on the calculation option, are described later.

The virtual register table 34 stores the virtual register numbers in association with the virtual addresses and data sizes. In other words, a single virtual register is referenced using the virtual register number allocated to the virtual register, and is expressed as a pair of virtual address and data size.

The calculation option includes a content identifier and a data size (in bytes). The content identifier is expressed as a combination of type, key ID, and data ID.

An example of the structure of the calculation option is a calculation option that can be used with Torus Fully Homomorphic Encryption (TFHE), which is one of the secret calculation technologies (secret operation technologies). The type is a TFHE data type, the key ID is a key number, and the data ID is a TFHE data identifier. The type is expressed as a value between 0 and 4, the key ID is expressed as a value greater than or equal to 0, and the data ID is expressed as a value greater than or equal to 0. Note that the torus in TFHE is a mathematical structure called an algebraic torus or a circular group, and is a multiplicative group T={z∈C: |z|=1}×defined by a set of points on a unit circle on a complex plane C, {z∈C: |z|=1}, and a binary operation “×”. In THE, a lattice cryptography called Torus Learning with Errors (TLWE) is used. The ciphertext of TFHE is called a TLWE sample, and is expressed as a vector of a torus. In the present embodiment, the torus is scaled and encoded as a 32-bit integer value.

The virtual register number in the virtual register table 34 described above is calculated (identified) from the content identifier in such a calculation option.

Returning to the explanation of FIG. 1, the page table 36 is a table for managing, for each page number, whether the storage destination of the data in the page is the main memory 32 or the storage. The page table 36 is stored in a nonvolatile memory provided in the node 20. The page table 36 may store, in association with each page number, a flag indicating the storage destination of the data and an actual address of the storage destination. In a case where the storage destination of the data is the storage, the storage may be the local storage device 14 or the storage device 54. The local storage device 14 also includes a storage medium and a storage controller. An example of the storage medium is a NAND flash memory. The local storage device 14 may be an SSD.

The memory management unit 38 stores the host data accompanying the I/O command in the main memory 32 by referring to the page table 36 according to the operation mode (described later) of the accelerator 10, and updates the virtual address of the virtual register table 34.

The calculation processor 40 refers to the virtual register table 34, processes the calculation instruction (calculation instruction using the host data) in accordance with the calculation option in the metadata accompanying the host data accompanying the I/O command, and encrypts the host data.

When relaying a capsule received from a certain node to another node, the relay table management unit 44 creates information to be added to the IP header and TCP header by referring to the relay table 42 (details will be described later). The relay table 42 is stored in the nonvolatile memory provided in the node 20.

The local storage device 14 is a storage used for paging.

The accelerator 10 may be configured to execute the processings of the memory management unit 38, the calculation processor 40, the relay table management unit 44, and the TCP processor 48 by one or more processing circuits (processors).

The processing by the processing circuit (processor) may be realized by the central processing unit (CPU) executing firmware, or realized by hardware. In addition, parts of the processing by the processing circuit may be realized by the CPU executing firmware, and remaining parts of the processing may be realized by hardware. The hardware is realized by at least one of registers, adders, multipliers, and other arithmetic units. The registers are realized by, for example, logic circuits such as flip-flops. The adders, multipliers, and other arithmetic units are realized by, for example, logic circuits.

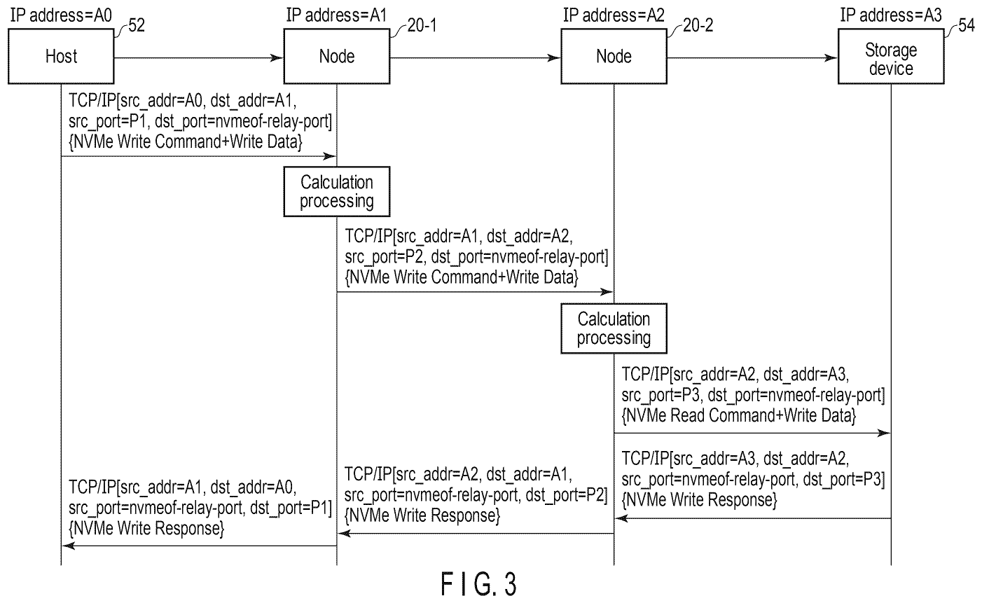

FIG. 3 illustrates an example of indirect communication between the host 52 and the storage device 54 according to the first embodiment.

A serial circuit of two nodes 20-1 and 20-2 is connected between the host 52 and the storage device 54. The host 52 comprises the accelerator 10. Each of the nodes 20-1 and 20-2 comprises the accelerator 10 and the local storage device 14. The storage device 54 comprises the accelerator 10 and the storage (e.g., solid state drive: SSD). The storage device 54 comprising the accelerator 10 is also referred to as a computing storage device (CSD) that processes computing instructions.

The Internet Protocol (IP) address of the host 52 is A0. The IP address of the node 20-1 is A1. The IP address of the node 20-2 is A2. The IP address of the storage device 54 is A3. In the network 22, transmission control protocol (TCP) defined in RFC 9293 is used as NVMe transport protocol. Since TCP operates on the Internet Protocol (IP). In the present embodiment, TCP also controls a header of IP datagram, the TCP message and the IP datagram are collectively referred to as TCP/IP message.

The TCP/IP message is expressed in the form of TCP/IP [header] {payload}. The header is a combination of the IP header and the TCP header. FIG. 3 shows only four fields: a source address (src_addr) and a destination address (dst_addr) of the IP header, and a source port number (src_port) and a destination port number (dst_port) of the TCP header. The payload is application data. In a case where TCP is used as NVMe transport, the application data is a capsule (command capsule or response capsule).

FIG. 3 illustrates a case where secret calculation is performed as an example of the calculation processing of each node 20. An example of secret calculation is a compute on write (CoW) processing that uses an NVMe write command. A command capsule is transmitted from the host 52 to the storage device 54 via the serial circuit of nodes 20-1 and 20-2. A response capsule is transmitted from the storage device 54 to the host 52 via the serial circuit of nodes 20-2 and 20-1.

The command capsule includes an NVMe write command and write data. The response capsule includes an NVMe write response. When the node 20-1 receives the command capsule including the NVMe write command and the write data from the host 52, it determines whether or not the write data satisfies a predetermined condition. When the node 20-2 receives the command capsule including the NVMe write command and the write data from the node 20-1, it determines whether or not the write data satisfies a predetermined condition. Note that the node 20-1 stores the write data in the main memory 32 as a virtual register. The node 20-2 stores the write data in the main memory 32 as a virtual register. In a case where the main memory has insufficient free space, the node 20-1 and the node 20-2 store the write data in the local storage device 14 or the storage device 54. In a case where the write data satisfies the predetermined condition, the node 20-1 and the node 20-2 perform secret calculation processing using the write data. The node 20-1 creates a command capsule that includes encrypted write data, which is the result of the secret calculation processing, and transmits the command capsule to the node 20-2. The node 20-2 creates a command capsule that includes the updated write data, which is the result of the secret calculation processing, and transmits the command capsule to the storage device 54.

The header of the TCP/IP message transmitted from the host 52 to the node 20-1 includes src_addr A0, dst_addr A1, src_port P1, and dst_port nvmeof-relay-port. Nvmeof-relay-port is a port number common to all nodes predefined in a network that uses NVMe-oF.

The header of the TCP/IP message transmitted from the node 20-1 to the node 20-2 will include src_addr A1, dst_addr A2, src_port P2, and dst_port nvmeof-relay-port.

The header of the TCP/IP message transmitted from the node 20-2 to the storage device 54 will include src_addr A2, dst_addr A3, src_port P3, and dst_port nvmeof-relay-port.

The header of the TCP/IP message transmitted from the storage device 54 to the node 20-2 includes src_addr A3, dst_addr A2, src_port nvmeof-relay-port, and dst_port P3.

The header of the TCP/IP message transmitted from the node 20-2 to the node 20-1 will include src_addr A2, dst_addr A1, src_port nvmeof-relay-port, and dst_port P2.

The header of the TCP/IP message transmitted from the node 20-1 to the host 52 will include src_addr A1, dst_addr A0, src_port nvmeof-relay-port, and dst_port P1.

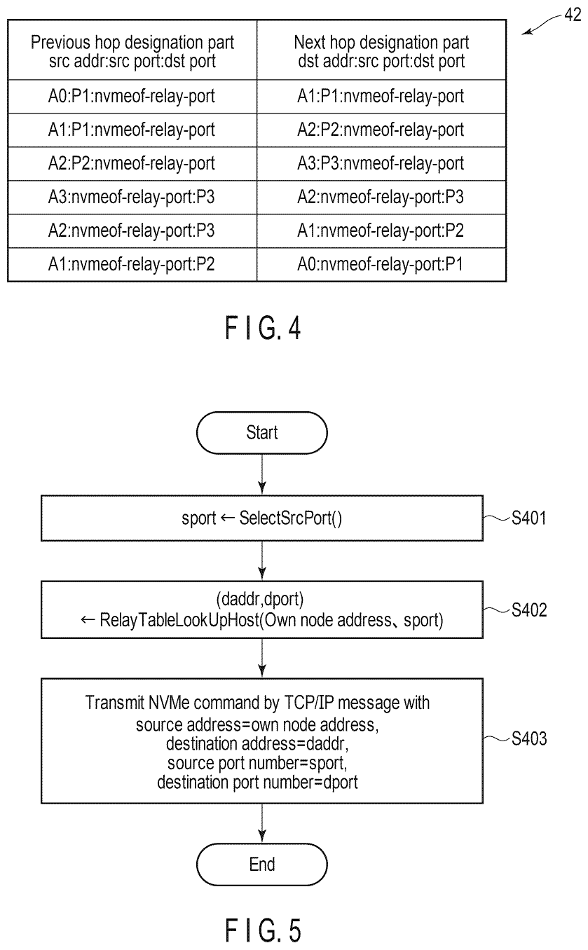

FIG. 4 illustrates an example of the relay table 42 according to the first embodiment.

The relay table 42 is used to create a TCP/IP message. In the first embodiment, the relay table 42 implemented in the host 52, the node 20-1, the node 20-2, and the storage device 54 stores the same information.

The relay table 42 includes a pair of previous hop designation part and next hop designation part. The previous hop designation part includes three fields: a source address, a source port number, and a destination port number. The next hop designation part includes three fields: a destination address, a source port number, and a destination port number.

A first record in the relay table 42 includes the previous hop designation part A0:P1:nvmeof-relay-port and the next hop designation part A1:P1:nvmeof-relay-port. The “:” indicates a field separator.

Before transmitting the TCP/IP message including a capsule in the payload, the relay table management unit 44 in the accelerator 10 of each of the host 52, the nodes 20-1 and 20-2, and the storage device 54 refers to the relay table 42 and searches for a record that includes the IP address of its own node as the source address of the previous hop designation part, the source port number of its own node as the source port number of the previous hop designation part, and nvmeof-relay-port as the destination port number of the previous hop designation part. In a case where a record that matches the condition exists as a result of the search, the relay table management unit 44 designates the destination address, the source port number, and the destination port number of the next hop designation part of the record matching the conditions as the destination address, the source port number, and the destination port number of the header, respectively.

In a case where the host 52 transmits the TCP/IP message that includes the command capsule, the first record in the relay table 42 matches the above condition. Therefore, the relay table management unit 44 uses the first record to create the TCP/IP header.

In a case where the node 20-1 transmits the TCP/IP message that includes the command capsule, the second record from the top of the relay table 42 matches the above condition. Therefore, the relay table management unit 44 uses the second record to create the TCP/IP header.

In a case where the node 20-2 transmits the TCP/IP message that includes the command capsule, the third record from the top of the relay table 42 matches the above conditions. Therefore, the relay table management unit 44 uses the third record to create the TCP/IP header.

In a case where the storage device 54 transmits the TCP/IP message that includes the response capsule, the fourth record from the top of the relay table 42 matches the above condition. Therefore, the relay table management unit 44 uses the fourth record to create the TCP/IP header.

In a case where the node 20-2 transmits the TCP/IP message that includes the response capsule, the fifth record from the top of the relay table 42 matches the above condition. Therefore, the relay table management unit 44 uses the fifth record to create the TCP/IP header.

In a case where the node 20-1 transmits the TCP/IP message that includes the response capsule, the sixth record (final record) from the top of the relay table 42 matches the above condition. Therefore, the relay table management unit 44 uses the final record to create the TCP/IP header.

The header created at each node by the method described above may be passed to the TCP processor 48 of each node as a parameter for a socket when each node creates a TCP socket.

The relay table management unit 44 and the network I/F 30 cooperate to form a connection that can be connected to the upstream node 24 or the downstream node 26 using the NVMe transport protocol. The connection is also referred to as a connection interface. In FIG. 3, the upstream node 24 is the host 52, the node 20-1, or the node 20-2, and the downstream node 26 is the storage device 54, the node 20-2, or the node 20-1. The connection or connection interface receives first data and the I/O command from the upstream node and transmits second data, which is the result of the calculation processing for the first data, and the I/O command to the downstream node.

FIG. 5 is a flowchart that explains an example of relay processing of the accelerator 10 in the host 52 according to the first embodiment.

The relay table management unit 44 selects the source port number using a function SelectSrcPort( ), and sets the source port number to a variable sport (step S401).

The relay table management unit 44 refers to the relay table 42 using a function RelayTableLookUpHost (own node address, sport) and searches for a record that includes the IP address of its own node as the source address of the previous hop designation part, the variable sport as the source port number of the previous hop designation part, and nvmeof-relay-port as the destination port number of the previous hop designation part. In a case where a record that matches the condition exists, the relay table management unit 44 sets the destination address of the next hop designation part of the record that matches the condition to a variable daddr and sets the destination port number of the next hop designation part to a variable dport (step S402).

The relay table management unit 44 transmits the NVMe command by the TCP/IP message having the TCP/IP header with the source address=own node address, the destination address=variable daddr, the source port number=variable sport, and the destination port number=variable dport (step S403). The variable dport is nvmeof-relay-port.

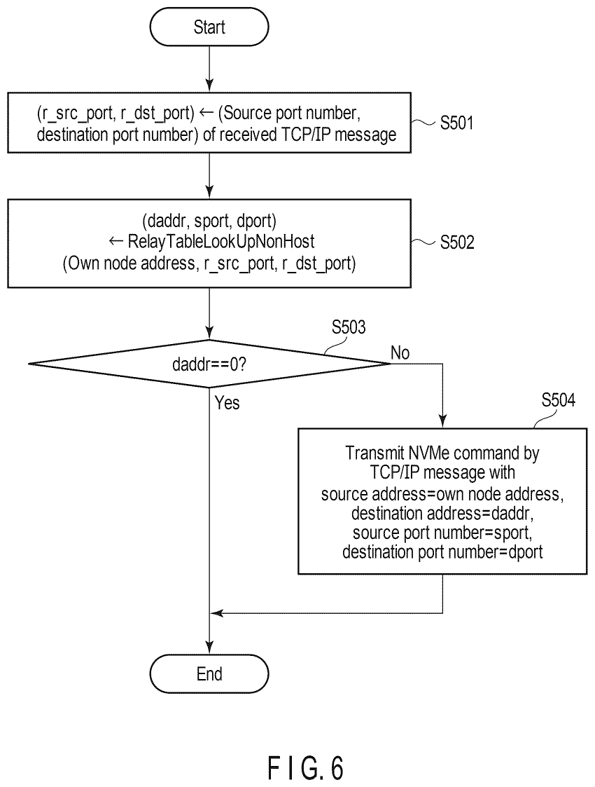

FIG. 6 is a flowchart illustrating an example of relay processing of the accelerator 10 in the node 20 or the storage device 54 according to the first embodiment.

The relay table management unit 44 sets the source port number of the received TCP/IP message to a variable r_src_port and sets the destination port number of the received TCP/IP message to a variable r_dst_port (step S501).

The relay table management unit 44 refers to the relay table 42 using a function RelayTableLookUpNonHost (own node address, r_src_port, r_dst_port) and searches for a record that includes the IP address of its own node as the source address of the previous hop designation part, the variable r_src_port as the source port number of the previous hop designation part, and the variable r_dst_port as the destination port number of the previous hop designation part. In a case where a record that matches the condition exists, the relay table management unit 44 sets the destination address of the next hop designation part of the record that matches the condition to the variable daddr, sets the source port number of the next hop designation part to the variable sport, and sets the destination port number of the next hop designation part to the variable dport (step S502).

The relay table management unit 44 determines whether or not the variable daddr is 0 (step S503). In a case where the variable daddr is 0 (step S503, Yes), the relay processing ends because the own node address is the final address. In a case where the variable daddr is not 0 (step S503, No), the relay table management unit 44 transmits the NVMe command by the TCP/IP message having the TCP/IP header with the source address=own node address, the destination address=variable daddr, the source port number=variable sport, and the destination port number=variable dport (step S504). The variable dport is nvmeof-relay-port.

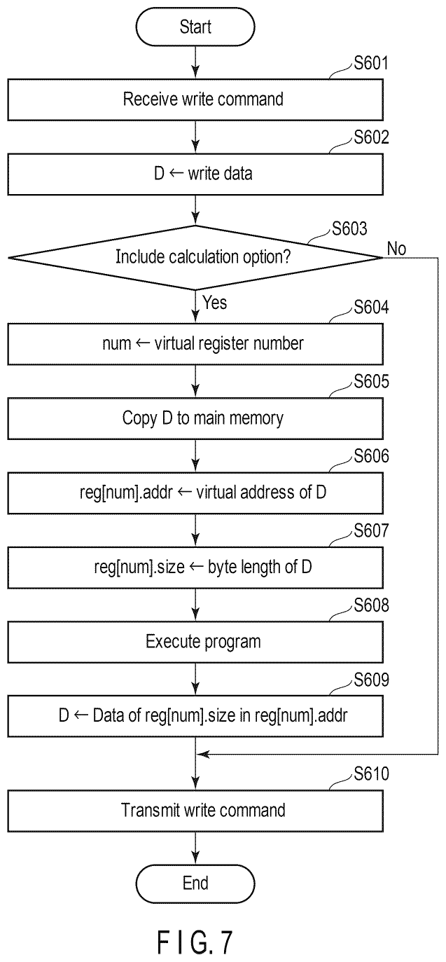

FIG. 7 is a flowchart illustrating an example of relay processing of the accelerator 10 in the node 20 or the storage device 54 according to the first embodiment in a case where the operation mode is the CoW mode. The CoW mode is an operation mode for processing a calculation instruction using host data (write data) accompanying a write command from the host 52.

The network I/F 30 receives a write command (I/O command) from the host 52 (step S601). The write command includes write data and a logical address used to access the write data.

When processing in step S601 is ended, the memory management unit 38 stores the write data included in the write command in a variable D (step S602).

The memory management unit 38 determines whether or not the metadata attached to the write data includes a calculation option (step S603).

In a case where the metadata includes the calculation option (step S603, Yes), the memory management unit 38 calculates a virtual register number based on the calculation option (content identifier) and stores the virtual register number in a variable num (step S604).

The memory management unit 38 copies the variable D (write data) to a free area of the main memory 32 (step S605).

The memory management unit 38 sets the virtual address indicating the memory area of the main memory 32 to which the variable D has been copied as the virtual address corresponding to the variable num in the virtual register table 34. The virtual address is an address referred to by the virtual register number stored in the variable num. In other words, the memory management unit 38 sets the top virtual address of the copy destination of the variable D to a virtual address field (reg[num].addr) of the variable num-th virtual register (step S606).

The memory management unit 38 sets a data size of the variable D as a data size corresponding to the variable num in the virtual register table 34. The data size is a size referred to by the virtual register number stored in the variable num. In other words, the memory management unit 38 sets a byte length of the variable D to a data size field (reg[num].size) of the variable num-th virtual register (step S607).

The calculation processor 40 executes a program stored in a program register by referring to the virtual register table 34 (step S608). The program register is a part of the virtual register. The virtual register is a register defined in a virtual address space. To execute the program in step S608 is equivalent to processing the calculation instruction using the write data. The write data (TLWE sample (described later)) that is a calculation target (a target when processing the calculation instruction) is read from a CoW register (described later).

When the processing of step S608 is executed, the data of the processing result (that is, the processing result of the calculation instruction using the write data) is stored in the virtual address set in the virtual address field (reg[num].addr) of the variable num-th virtual register.

The memory management unit 38 refers to the virtual register table 34, reads data of a byte length (number of bytes) of the data size set in the data size field (reg[num].size) of the virtual register from the virtual address set in the virtual address field of the variable num-th virtual register, and copies the data to the variable D (step S609).

When the processing of step S609 is executed, the network I/F 30 transmits a write command (a write command for the variable D) that includes the variable D as the write data to the next hop node (S610).

The end of the program is a return instruction (Return num) with the variable num as an argument.

In a case where it is determined in step S603 that the metadata attached to the write data does not include the calculation option (step S603, No), the processing in step S610 is executed.

According to the processing shown in FIG. 6 and FIG. 7, the node 20-1 can process the calculation instruction based on the write command transmitted from the host 52, and transmit the processing result as the write data to the storage device 54 via the next-hop node 20-2. The node 20-1 can store the processing result of the calculation instruction using the write data in main memory 32 as the write data.

Similarly, the node 20-2 can process the calculation instruction based on the write command transmitted from the node 20-1, and transmit the processing result as the write data to the storage device 54. The node 20-2 can store the processing result of the calculation instruction using the write data in the main memory 32 as the write data. The write data stored in the main memory 32 can be used when processing the calculation instruction.

Nodes 20-1 and 20-2 can perform calculation processing based on a read command as well as a write command, and store the calculation processing result as read data in the main memory 32.

Next, an example of a set of secret calculation instructions used by the accelerator 10 is shown.

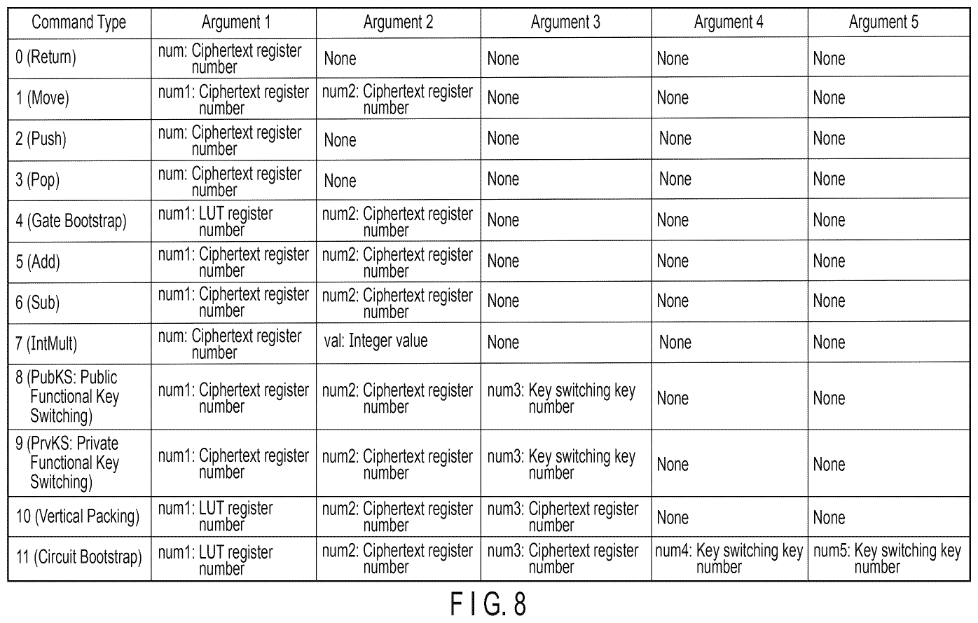

FIG. 8 illustrates an example of the secret calculation instructions according to the first embodiment.

An example of the secret calculation instructions includes a Return instruction, a Move instruction, a Push instruction, a Pop instruction, a Gate Bootstrap instruction, an Add instruction, a Sub instruction, an IntMult instruction, a Public Functional Key Switching (PubKS) instruction, a Private Functional Key Switching (PrvKS) instruction, a Vertical Packing instruction, and a Circuit Bootstrap instruction.

A ciphertext register number represents a virtual register number for referencing a ciphertext register. An LUT register number represents a virtual register number for referencing a look-up table (LUT) register.

The Return instruction corresponds to a command type 0. An argument of the Return instruction is a ciphertext register number num. The Return instruction causes a value of the ciphertext register referenced by the ciphertext register number num to be transmitted to an adjacent node. In a case where the ciphertext register is a CoR register, the value of the ciphertext register is transmitted to an upstream adjacent node. In a case where the ciphertext register is a CoW register, the value of the ciphertext register is transmitted to a downstream adjacent node. After the value of the ciphertext register is transmitted, a stack pointer, which is used to manage a reference position of a stack area in the virtual address space, is set to 0.

The Move instruction corresponds to a command type 1. An “argument 1” of the Move instruction is a ciphertext register number num1, and an “argument 2” is num2. The Move instruction causes the value of the ciphertext register referenced by the ciphertext register number num1 to be copied to the ciphertext register referenced by the ciphertext register number num2.

The Push instruction corresponds to a command type 2. An argument of the Push instruction is the ciphertext register number num. The Push instruction causes the value of the ciphertext register referenced by the ciphertext register number num to be copied to the top of the stack area in the virtual address space, and causes the stack pointer is decremented (one is subtracted from the stack pointer value).

The Pop instruction corresponds to a command type 3. An argument of the Pop instruction is the ciphertext register number num. The Pop instruction causes the value at the top of the stack area in the virtual address space to be copied to the ciphertext register referenced by the ciphertext register number num, and causes the stack pointer to be incremented (one is added to the stack pointer value).

The Gate Bootstrap (GBS) instruction corresponds to a command type 4. An “argument 1” of the Gate Bootstrap instruction is an LUT register number num1, and an “argument 2” is the ciphertext register number num2. The Gate Bootstrap instruction causes GBS or programmable bootstrapping (PBS) to be executed on the value of the ciphertext register referenced by the ciphertext register number num2, using the LUT register referenced by the LUT register number num1. For example, in a case where the LUT register number num1=0, GBS is executed, and in a case where the LUT register number num1>0, PBS is executed. The execution result (output value) of GBS or PBS is copied to the ciphertext register referenced by the ciphertext register number num2. For example, in a case where the value of the LUT register referenced by the LUT register number num1 is an LUT for function f(x), and the value of the ciphertext register referenced by the ciphertext register number num2 before executing the Gate Bootstrap instruction is a TLWE sample for f(x), the value of the ciphertext register referenced by the ciphertext register number num2 after executing the Gate Bootstrap instruction becomes a TLWE sample for f(x). A CMux function is used in Blind Rotate processing executed in the Gate Bootstrap instruction.

The Add instruction corresponds to a command type 5. An “argument 1” of the Add instruction is the ciphertext register number num1, and an “argument 2” is num2. The Add instruction causes the value of the ciphertext register referenced by the ciphertext register number num1 and the value of the ciphertext register referenced by the ciphertext register number num2 to be added for each vector component, and causes the result of this addition (calculation result) to be copied to the ciphertext register referenced by the ciphertext register number num1.

The SUB instruction corresponds to a command type 6. An “argument 1” of the SUB instruction is the ciphertext register number num1, and an “argument 2” is num2. The SUB instruction cause the value of the ciphertext register referenced by the ciphertext register number num2 to be subtracted from the value of the ciphertext register referenced by the ciphertext register number num1 for each vector component, and causes the result of this subtraction (calculation result) to be copied to the ciphertext register referenced by the ciphertext register number num1.

The IntMlt instruction corresponds to a command type 7. An “argument 1” of the IntMlt instruction is the ciphertext register number num, and an “argument 2” is an integer value val. The IntMlt instruction causes the value of the ciphertext register referenced by the ciphertext register number num to be multiplied by the integer value val for each vector component, and causes the result of this multiplication (calculation result) to be copied to the ciphertext register referenced by the ciphertext register number num.

The PubKS instruction corresponds to a command type 8. An “argument 1” of the PubKS instruction is the ciphertext register number num1, an “argument 2” is the ciphertext register number num2, and an “argument 3” is a key switching key number num3. The key switching key number in the PubKS instruction is a virtual register number for referencing a PubKS key (PubKSK) register. The PubKS instruction causes public functional key switching using the key switching key stored in the PubKS key register referenced by the key switching key number num3 to be executed for the value of ciphertext register referenced by the ciphertext register number num1 (i.e., ciphertext), and causes the ciphertext after applying the public functional key switching to be stored in the ciphertext register referenced by the ciphertext register number num2. An example of a function in the PubKS instruction is an identity function (f(x)=x).

The PrvKS instruction corresponds to a command type 9. An “argument 1” of the PrvKS instruction is the ciphertext register number num1, an “argument 2” is num2, and an “argument 3” is the key switching key number num3. The key switching key number in the PrvKS instruction is a virtual register number for referencing a PrvKS key (PrvKSK) register. The PrvKS instruction causes private functional key switching using the key switching key stored in the PrvKSK register referenced by the key switching key number num3 to be executed for the value of ciphertext register referenced by the ciphertext register number num1 (i.e., ciphertext), and causes the ciphertext after applying the private functional key switching to be stored in the ciphertext register referenced by the ciphertext register number num2. The PrvKSK register referenced by the key switching key number num3 stores (k+1) key switching keys for public functional key switching as one key switching key for private functional key switching. Specifically, the key switching key stored in the PrvKSK register is obtained by encrypting a function (f_u(x)=−Ku·x if u≤k, otherwise f_u(x)=1·x if u=k+1) for x=k_i/2j (1≤i≤n+1, 1≤j≤t) in (k+1) TLWE (or TRLWE) samples. “·” is a symbol that represents multiplication of an integer and a torus. In a case where k=1, two pieces are counted as one private functional key switching key (PrvKSK).

In a case where the first embodiment is applied to a system for multiparty computation (key switching type multiparty computation), a plurality of PubKSK registers and a plurality of PrvKSK registers may exist for each ciphertext register. For this reason, in the “argument 3” of the PubKSK instruction and the “argument 3” of the PrvKSK instruction, the key switching key number is explicitly specified for referring to the PubKS register and PrvKS register to be used.

The Vertical Packing instruction corresponds to a command type 10. The Vertical Packing instruction is an instruction that executes a vertical packing (VP) algorithm. Am “argument 1” of the Vertical Packing instruction is the LUT register number num1, an “argument 2” is the ciphertext register number num2, and an “argument 3” is num3. Num1 is the virtual register number that includes “s” LUTs used to calculate each output bit of an arbitrary d-bit input/s-bit output function used in VP. Num2 is the virtual register number of the ciphertext register that includes “d” TRGSW samples. Num3 is the virtual register number of the ciphertext register that includes “s” TLWE samples. The Vertical Packing instruction causes the Blind Rotate processing to be executed “s” times, during which the CMux function is used. Each of the “s” samples output by performing the Blind Rotate processing “s” times is converted into the TLWE sample by sample extract processing.

The Circuit Bootstrap instruction corresponds to a command type 11. The Circuit Bootstrap instruction is an instruction that executes Circuit Bootstrapping (CBS). An “argument 1” of the Circuit Bootstrap instruction is the LUT register number num1, an “argument 2” is the ciphertext register number num2, an “argument 3” is num3, an “argument 4” is a key switching key number num4, and an “argument 5” is num5. Num1 is the virtual register number that includes the LUT used in the CBS. Num2 is the virtual register number for the ciphertext register that includes “s” TLWE samples. Num3 is the virtual register number for the ciphertext register that includes “s” TRGSW samples. Num4 is the virtual register number for the PubKSK. Num5 is the virtual register number for PrvKSK NTT. The CMux function is used in Blind Rotate processing executed in the Circuit Bootstrap instruction.

The host 52 describes the calculation processings using the secret calculation instructions shown in FIG. 8 in the calculation option. As a result, the accelerator 10 can execute the Circuit Bootstrap instruction and transmit the ciphertext after executing the Circuit Bootstrap instruction as the write data to the adjacent node.

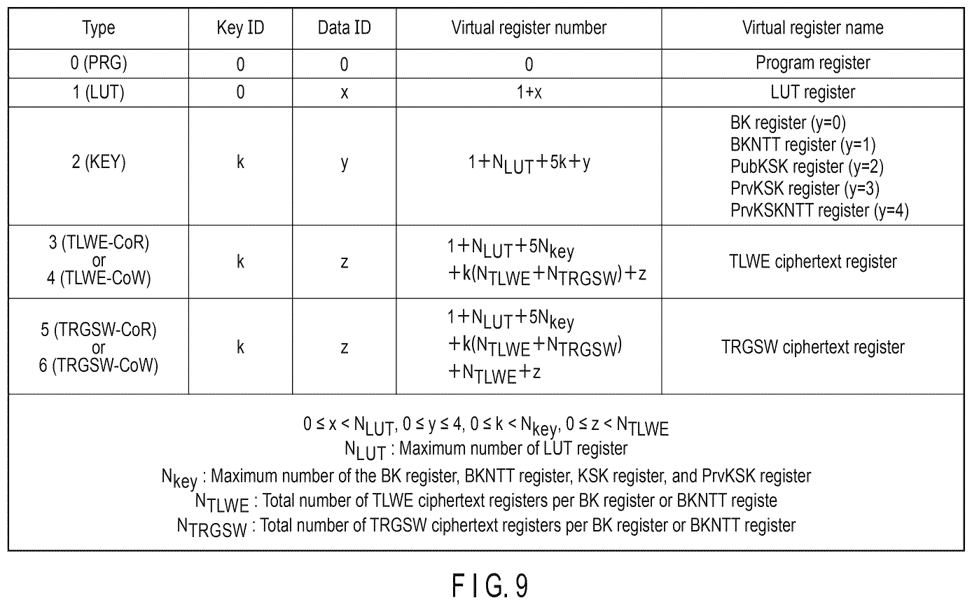

FIG. 9 illustrates an example of the virtual register number according to the first embodiment.

The virtual registers in the present embodiment include the program register, the LUT register, a BK register, a BKNTT register, the PubKS register, the PrvKSK register, a PrvKSKNTT register, a TLWE ciphertext register, and a TRGSW ciphertext register. The actual entities of these registers exist in the main memory 32.

The type of the program register is 0 (PRG), the key ID is 0, the data ID is 0, and the virtual register number is 0. The program register stores a program (a sequence of calculation instructions).

The type of the LUT register is 1 (LUT), the key ID is 0, the data ID is x, and the virtual register number is 1+x. The LUT register stores a test vector for THE. An example of the test vector (LUT) stored in the LUT register is a coefficient for a predetermined function (polynomial).

The type of the BK register is 2(KEY), the key ID is k, the data ID is y (=0), and the virtual register number is 1+N_{LUT}+5k+y. The BK register stores a bootstrapping key for TFHE. The bootstrapping key stored in the BK register is used in GBS of TFHE, etc. The bootstrapping key may also be used in programmable bootstrapping (PBS). PBS is a bootstrapping method that outputs a TLWE sample obtained by homomorphically evaluating the input TLWE sample (ciphertext) using a predetermined function, after reducing the noise of the TLWE sample to the noise level of a fresh sample.

The type of the BKNTT register is 2(KEY), the key ID is k, the data ID is y (=1), and the virtual register number is 1+N_{LUT}+5k+y. The BKNTT register stores the bootstrapping key of TFHE that has been applied number theory transformation processing.

The type of the PubKSK register is 2(KEY), the key ID is k, the data ID is y (=2), and the virtual register number is 1+N_{LUT}+5k+y. The PubKSK register stores the key switching key of TFHE. Specifically, the PubKSK register stores the key switching key used in public functional key switching. The key switching key stored in the PubKSK register is usually used in a post-processing of the above-mentioned GBS or PBS (i.e., bootstrapping processing).

The type of the PrvKSK register is 2(KEY), the key ID is k, the data ID is y (=3), and the virtual register number is 1+N_{LUT}+5k+y. The PrvKSK register stores the key switching key of TFHE. Specifically, the PrvKSK register stores the key switching key used in the private functional key switching. The key switching key stored in the PrvKSK register is usually used in the post-processing of the above-mentioned GBS or PBS (i.e., bootstrapping processing).

The type of the PrvKSKNTT register is 2(KEY), the key ID is k, the data ID is y (=4), and the virtual register number is 1+N_{LUT}+5k+y. The PrvKSKNTT register stores the PrvKSK that has been applied a number theory transformation.

The type of the TLWE ciphertext register is 3 (TLWE-COR) or 4 (TLWE-CoW), the key ID is k, the data ID is z, and the virtual register number is 1+N_{LUT}+5N_{key}+k (N_{TLWE}+N_{TRGSW})+z. The TLWE ciphertext register stores the TLWE sample. The TLWE ciphertext register includes two types of registers: TLWE-COR (COR register) and TLWE-CoW (CoW register).

The type of the TRGSW ciphertext register is 5 (TRGSW-CoR) or 6 (TRGSW-CoW), the key ID is k, the data ID is z, and the virtual register number is 1+N_{LUT}+5N_{key}+k (N_{TLWE}+N_{TRGSW})+N_{TLWE}+z. The TRGSW ciphertext register stores the TRGSW sample. The TRGSW ciphertext register includes two types of registers: TRGSW-COR (CoR register) and TRGSW-CoW (CoW register).

In FIG. 9, in a case where the type of the virtual register is 0, the key ID is 0, and the data ID is 0, the virtual register number (=0) is calculated from the type, the key ID, and the data ID (i.e., the content identifier). It is indicated that the virtual register is the program register.

In a case where the type of the virtual register is 1, the key ID is 0, and the data ID is x, the virtual register number (=1+x) is calculated from the type, the key ID, and the data ID (i.e., the content identifier). It is indicated that the virtual register is the LUT register.

In a case where the type of the virtual register is 2, the key ID is k, and the data ID is y, the virtual register number (=1+N_{LUT}+5k+y) is calculated from the type, the key ID, and the data ID (i.e., the content identifier). It is indicated that the virtual register is the BK register, the BKNTT register, the PubKSK register, the PrvKSK register, or the PrvKSKNTT register. When y=0, the virtual register is the BK register. When y=1, the virtual register is the BKNTT register. When y=2, the virtual register is the PubKSK register. When y=3, the virtual register is the PrvKSK register. When y=4, the virtual register is the PrvKSKNTT register.

In a case where the type of the virtual register is 3 or 4, the key ID is k, and the data ID is z, the virtual register number (=1+N_{LUT}+5N_{key}+k (N_{TLWE}+N_{TRGSW})+z) is calculated from the type, the key ID, and the data ID (i.e., the content identifier). It is indicated that the virtual register is the TLWE ciphertext register. In a case where the type is 3, this indicates that the virtual register is the TLWE-COR (COR register). In a case where the type is 4, this indicates that the virtual register is the TLWE-CoW (CoW register).

In a case where the type of the virtual register is 5 or 6, the key ID is k, and the data ID is z, the virtual register number (=1+N_{LUT}+5N_{key}+k (N_{TLWE}+N_{TRGSW})+N_{TLWE}+z) is calculated. It is indicated that the virtual register is the TRGSW ciphertext register. In a case where the type is 5, it indicates that this virtual register is the TRGSW-COR (CoR register). In a case where the type is 6, it indicates that this virtual register is the TRGSW-COW (CoW register).

“x” is assumed to be an integer greater than or equal to 0 and less than N_{LUT} (0≤x<N_{LUT}). “y” is assumed to be an integer greater than or equal to 0 and less than or equal to 4 (0≤y≤4). “k” is assumed to be an integer greater than or equal to 0 and less than N_{key} (0≤k<N_{key}). “z” is assumed to be an integer greater than or equal to 0 and less than N_{TLW} (0≤z<N_{TLW}).

N_{LUT} is the maximum number of the LUT registers. N_{key} is the maximum number of the BK registers, BKNTT registers, PubKSK registers, PrvKSK registers, and PrvKSKNTT registers. N_{TLWE} is the total number of the TLWE ciphertext registers per BK register or BKNTT register. N_{TRGSW} is the total number of the TRGSW ciphertext registers per BK register or BKNTT register.

The management of the relay table 42 will be described.

First, a creation of the relay table 42 will be described. There are three main options for a creation method. The embodiment can be appropriately realized using any of these creation methods.

A first method is to create a relay table during a design stage of the storage system 2 and install it on each accelerator 10 of the host 52, the node 20, and the storage device 54. In this method, the configuration of each unit of the host 52, the node 20, and the storage device 54 cannot be changed dynamically; however, this is not a problem if the storage system 2 is small in scale, and an administrator of the storage system 2 can configure information for the previous hop designation part and the next hop designation part. The relay table 42 can be installed in each accelerator 10 via a vendor-specific function of the NVMe transport protocol. Alternatively, the relay table 42 may be installed in each accelerator 10 by the administrator directly operating each accelerator 10 via a control interface such as a universal asynchronous receiver/transmitter (UART).

A second method is a method in which the accelerator 10 itself creates the relay table 42. The relay table management unit 44 of the accelerator 10 that adopts this method comprises a function for performing a neighbor search and detects the host 52, the node 20, and the storage device 54 that exist in the storage system 2. This neighbor search function may use an existing communication protocol such as a simple service discovery protocol (SSDP) by extending it to add information indicating that it corresponds to the present embodiment, or it may use a dedicated communication protocol. The relay table management unit 44 collects the IP address and port number at which the node corresponding to the present embodiment awaits connections, and thereby collects information corresponding to the source address and information corresponding to the source port number of the previous hop designation part and information corresponding to the destination address and information corresponding to the destination port number of the next hop designation part in the relay table 42 shown in FIG. 4. The relay table management unit 44 creates one entry in the relay table 42 for each piece of collected information by setting the port number used to wait for connections from other nodes as the destination port number in the previous hop designation part, and the port number used to connect to other nodes as the source port number in the next hop designation part. By performing this for each piece of collected information, the relay table 42 is created.

A third method is a method that creates a relay route and creates route control table entries at each node simultaneously. The relay table management unit 44 of the accelerator 10 that adopts this method sequentially creates the relay route based on instructions from the host 52 that issues the NVMe command. Suppose that the relay table management unit 44 receives from the host 52 a request to establish a relay route from the node 20-1 to the node 20-2. The relay table management unit 44 creates an entry using the IP address and port number of the host 52 notified by the host 52 as the source address and source port number of the previous hop designation part, and using the IP address and port number of the node 20-2 instructed by the host 52 as the destination address and destination port number of the next hop designation part. A port number that was determined in advance with the host 52 or a port number that is notified to the host 52 in response to an establishment request may also be used as the destination port number in the previous hop designation part. If there is a port number that has been determined in advance between the node itself (node 20-1) and the node 20-2, this may be used as the source port number in the next hop designation part. If there is no port number that has been determined in advance, a port number determined by the node itself (node 20-1) may be used as the source port number in the next hop designation part. It is assumed that the host 52 instructs each node in the route to establish a relay route; however, this is not limited thereto. For example, the host 52 may transfer a relay route establishment instruction including information on all the nodes on the route to a certain node 20, and then have that instruction forwarded to the next node 20 in a bucket-relay fashion, so that a route is established all the way to the end of the relay route. In this case, the relay table management unit 44 of each node can wait for a response from the node to which a message is to be transmitted before creating an entry in the relay table 42, thereby avoiding a situation in which an error occurs during the route establishment process and an indefinite entry remains.

In the third creation method, when the establishment request is transferred to the end storage device 54 in a bucket-relay fashion, the relay table management unit 44 may analyze and process information related to the bucket relay at the level of the application program being executed, or may improve and utilize an existing communication protocol. Examples of the latter are processes using the SRv6 Header defined in RFC 8754, or processes using the Network Service Header defined in RFC 8300 based on the concept of Service Function Chaining defined in RFC 7665.

Next, the handling of the source port number in the relay table 42 will be described in more detail.

In the previous explanation (especially the first and second creation methods of the relay table 42), the value of the source port number is determined when the relay table 42 entry is created. However, in actual TCP communication, the source port can be determined dynamically when establishing a TCP connection. In this case, the source port number that the message source node uses for TCP communication is not known until the request is received. The same applies to the source port number when starting communication from the node itself to the destination node of the message. If this operation were permitted, it would be impossible to create an entry in the relay table 42 until communication has started. On the other hand, in order to prevent connection requests from unknown nodes, there is a requirement to know in advance only the IP addresses of the message source node and the message destination node. To meet this requirement, an entry may be created in which the source port number in the previous hop designation part and the source port number in the next hop designation part are set to arbitrary values, and the source port number portion of the entry may be updated when communication starts. The communication start time is when the relay route is established. To be more precise, there are two possibilities for when communication starts: when a TCP connection is established, and when NVMe/TCP connection is established. However, either timing is acceptable as long as an appropriate response is made when an error occurs. Rather than updating the entry itself to allow any source port, a new entry may be added that includes all the information derived from that entry.

In the first and second creation methods of the relay table 42 described above, all nodes of the storage system 2 share a single relay table 42. In the third creation method, on the other hand, a different relay table 42 is created for each node according to the adjacent node to which it is connected (the message source node and the message destination node). In the present embodiment, all nodes may share a single relay table 42, or each node may have a different relay table 42. In other words, in the first creation method, the host 52 may instruct each node 20 to maintain a different relay table 42. In the second creation method, there is no problem if the information collected by the relay table management unit 44 differs for each node. In this state, a process may be added in which each node exchanges the relay table 42 that it has created to create a single relay table 42 as a whole.

According to the first embodiment, each node 20 can execute calculation processing on data based on an I/O command transmitted from the upstream node 24 and transmit the processing result to the downstream node 26. In this manner, it is possible to connect at least one node 20 between the host 52 and the storage device 54, perform calculation processing of data at the at least one node 20, and transmit the calculation processing to the storage device 54 while relaying it between the nodes 20.

### Second Embodiment

In a second embodiment, in a case where a plurality of nodes 20 are connected between the host 52 and the storage device 54, the host 52 controls whether to transmit an I/O command to the storage device 54 via one of the plurality of nodes 20 or to transmit an I/O command directly to the storage device 54.

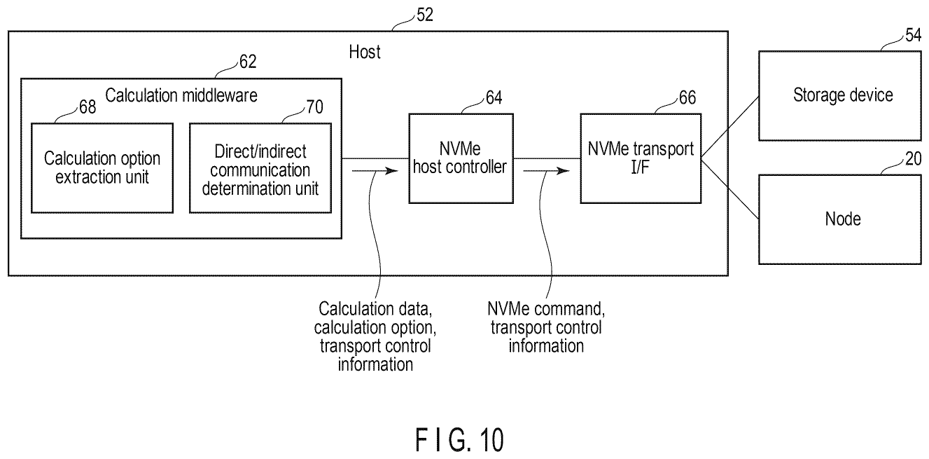

FIG. 10 illustrates an example of a configuration of the host 52 according to the second embodiment. The host 52 is connected to at least one of at least one storage device 54 and at least one nodes 20. Although not shown in FIG. 10, the host 52 may be connected to the storage device 54 and/or the node 20 via a network. In the second embodiment, the node 20 has a calculation processing function for host data, but the storage device 54 does not have the calculation processing function. The host 52 executes an application program. The host data is created by the application program. The host 52 issues an I/O command to write the host data to the storage device 54. The I/O command is accompanied by the host data. The host 52 may write the host data to the storage device 54 via the node 20. In this case, a calculation processing is performed on the host data by the node 20, and the processing result is transmitted from the node 20 as the host data.

In a case where the application program causes the node 20 to perform the calculation processing of the host data, it creates a calculation option that represents the processing, and includes the calculation option in metadata accompanying the host data. In a case where the application program does not cause the node 20 to perform the calculation processing of the host data, it does not create a calculation option. Therefore, in this case, the metadata accompanying the host data does not include the calculation option.

The host 52 comprises calculation middleware 62, an NVMe host controller 64, and an NVMe transport I/F 66. The calculation middleware 62 receives a write request or a read request for the host data from the application program.

The calculation middleware 62 comprises a calculation option extraction unit 68 and a direct/indirect communication determination unit 70. The calculation option extraction unit 68 extracts a calculation option from the read request or the write request with a calculation option passed from the application program. The direct/indirect communication determination unit 70 determines whether to transmit calculation data to the storage device 54 (direct communication) or to transmit it to the storage device 54 via a node (indirect communication) according to the calculation option extracted by the calculation option extraction unit 68. The direct/indirect communication determination unit 70 outputs transport control information that includes the determination result indicating either direct communication or indirect communication. An example of a calculation option is a secret calculation.

The NVMe host controller 64 receives the calculation data, calculation option, and transport control information from the calculation middleware 62, and creates command that includes the calculation data or the calculation option and the transport control information. In a case where the storage device 54 and the node 20 support the function of including the calculation option in metadata, the NVMe host controller 64 includes the calculation option in the metadata and creates a single NVMe command that includes the metadata. In a case where the storage device 54 and the node 20 do not support the function of including the calculation option in the metadata, the NVMe host controller 64 creates an NVMe command that includes the calculation data and an NVMe command that includes the calculation option. The processing content of the NVMe host controller 64 may be configured to be executed by one or more processing circuits (processors). Processing by the processing circuit (processor) may be realized by a central processing unit (CPU) executing firmware, or by hardware. In addition, some of the processing by the processing circuit may be realized by the CPU executing firmware, and other processing may be realized by hardware. The hardware is realized by at least one of registers, adders, multipliers, and other arithmetic units. The registers are realized by, for example, logic circuits such as flip-flops. The adders, multipliers, and other arithmetic units are realized by, for example, logic circuits.

The NVMe transport I/F 66 inputs the NVMe command and the transport control information from the NVMe host controller 64. In a case where the determination result in the transport control information indicates direct communication, the NVMe transport I/F 66 transmits the NVMe command directly to the storage device 54 using a transport protocol port number 4420 (NVM Express over Fabric storage access) as a destination port number. “4420” is defined as the port number for the storage device in the NVMe transport protocol. In a case where the determination result indicates indirect communication, the NVMe transport I/F 66 uses a fixed transport protocol port number relay-port-num, which can be used in the NVMe transport protocol other than 4420, as the destination port number, and transmits the NVMe command to one of the one or more nodes. The port number relay-port-num represents the port number of the node 20. The NVMe transport I/F 66 is connected to the storage device 54 and the node 20 via Ethernet, etc. The NVMe transport I/F 66 transmits the NVMe command as a command capsule as shown in FIG. 3.

The transport control information may further include a source port number. For example, the host 52 may comprise a first transmission port for transmitting a message to the storage device 54 and a second transmission port for transmitting a message to the node 20-1. The NVMe transport I/F 66 may select one of the one or more nodes 20 using the source port number in the transport control information. In a case where the source port number indicates the first transmission port, the NVMe transport I/F 66 may communicate directly. In a case where the source port number indicates the second transmission port, the NVMe transport I/F 66 may communicate indirectly.

The calculation middleware 62 and the NVMe host controller 64 may be realized in software by the CPU of the host 52. The NVMe transport I/F 66 includes hardware parts such as a PCIe controller and an Ethernet controller. The part of the NVMe transport I/F 66 that is not hardware may be realized in software by the CPU of the host 52.

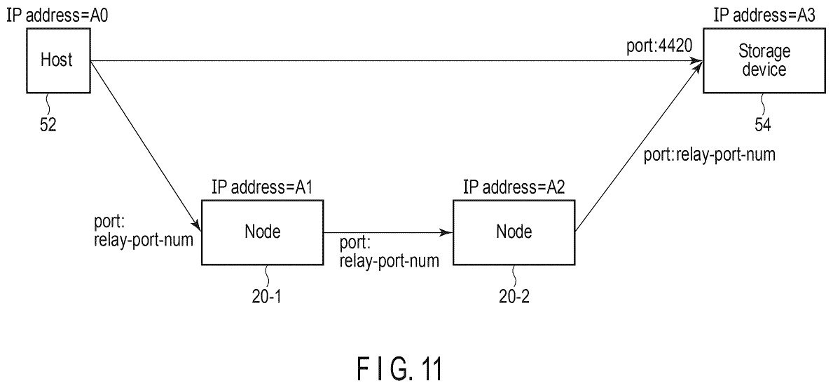

FIG. 11 illustrates an example of indirect communication between the host 52 and the storage device 54 according to the second embodiment.

A path from the host 52 to the storage device 54 includes two types of paths: an indirect path of (host 52)-(node 20-1)-(node 20-2)-(storage device 54) and a direct path from the host 52 to the storage device 54.

A method of transferring a TCP/IP message over the indirect path is the same as the method of transferring a message using the relay table 42 in the network configuration shown in FIG. 3. A command capsule is transmitted from the host 52 to the storage device 54 via zero or more relay nodes 20, and in response thereto, a response capsule is transmitted from the storage device 54 to the host 52 via zero or more relay nodes 20. To pass through zero relay nodes means a direct path. The host data of a TCP/IP message is a capsule (command capsule or response capsule).

A method of transferring a TCP/IP message over the direct path is the same as the case of using a TCP transport in a normal NVMe-oF.

The direct/indirect communication determination unit 70 notifies the NVMe host controller 64 whether to use the direct path or the indirect path based on the destination port number. In a case where the destination port number is 4420, the NVMe host controller 64 uses the direct path. In a case where the destination port number is relay-port-num, the NVMe host controller 64 uses the indirect path.

The direct/indirect communication determination unit 70 may notify the NVMe host controller 64 to use the direct path in a case where there is no calculation option, as calculation processing by the node is not required, and to use the indirect path in a case where there is a calculation option.

According to the second embodiment, in a case where at least one node 20 is arranged between the host 52 and the storage device 54, the host 52 controls whether to transmit the capsule indirectly to the storage device 54 via at least one node 20 or to transmit the capsule directly to the storage device 54.

### Third Embodiment

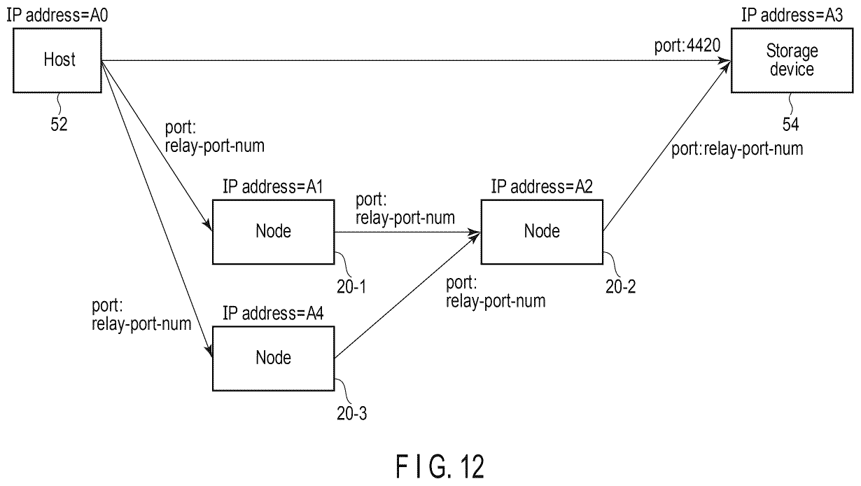

FIG. 12 illustrates an example of an indirect communication network configuration between the host 52 and the storage device 54 according to a third embodiment.

As with the network configuration shown in FIG. 11, there are two types of paths in also the network configuration shown in FIG. 12: an indirect path and a direct path. Unlike the second embodiment, there are two types of indirect paths from the host 52 to the storage device 54: a first indirect path of (host 52)-(node 20-1)-(node 20-2)-(storage device 54) and a second indirect path of (host 52)-(node 20-3)-(node 20-2)-(storage device 54).

A command capsule is transmitted from the host 52 to the storage device 54 via zero or more nodes 20, and in response thereto, a response capsule is transmitted from the storage device 54 to the host 52 via zero or more nodes. To pass through zero nodes means a direct path. Host data of a TCP/IP message is a capsule (command capsule or response capsule).

A method of transferring a TCP/IP message over the indirect path is the same as the method of transferring a message using the relay table 42 in the network configuration shown in FIG. 3. However, the relay table 42 is different from the one shown in FIG. 4.

A method of transferring a TCP/IP message over the direct path is the same as in a case of using a TCP transport in a normal NVMe-oF.

A direct/indirect communication determination unit 70 notifies the NVMe host controller 64 whether to use the direct path or the indirect path based on a destination port number. In a case where the destination port number is 4420, the NVMe host controller 64 uses the direct path. In a case where the destination port number is relay-port-num, the NVMe host controller 64 uses the indirect path.

The direct/indirect communication determination unit 70 may select the direct path when a calculation option is empty, and may select the indirect path when a calculation option exists. The direct/indirect communication determination unit 70 may notify the NVMe host controller 64 of whether to use an indirect path 1 or an indirect path 2 based on a source port number.

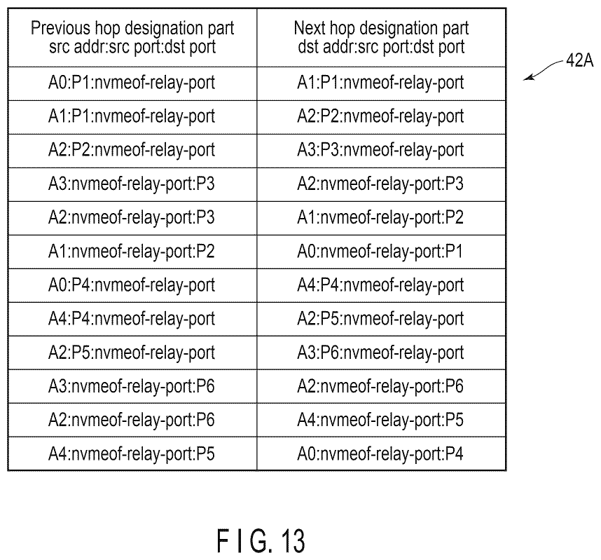

FIG. 13 illustrates an example of a relay table 42A according to the third embodiment.

First six entries of the relay table 42A are the same as all six entries of the relay table 42. The headers of TCP/IP messages using the first six entries of the relay table 42A are the same as those shown in FIG. 3. A relay control algorithm using the relay table 42A is the same as that shown in FIG. 5 and FIG. 6.

The header of the TCP/IP message transmitted from the host 52 to the node 20-1 includes src_addr A0, dst_addr A1, src_port P1, and dst_port nvmeof-relay-port. Nvmeof-relay-port is a common port number that is predefined in a system that uses NVMe-OF. The source port number from which the host 52 transmits a message to the node 20-1 is P1.

The header of the TCP/IP message transmitted from the node 20-1 to the node 20-2 will be src_addr A1, dst_addr A2, src_port P2, and dst_port nvme-of-relay-port.

When the node 20-2 receives the TCP/IP message from the node 20-1 whose TCP/IP header includes src_addr A1, dst_addr A2, src_port P2, and dst_port nvmeof-relay-port, the header of the TCP/IP message transmitted from the node 20-2 to the storage device 54 will be src_addr A2, dst_addr A3, src_port P3, and dst_port nvmeof-relay-port.

When the storage device 54 receives the TCP/IP message from the node 20-2 whose TCP/IP header includes src_addr A2, dst_addr A3, src_port P3, and dst_port nvmeof-relay-port, the header of the TCP/IP message transmitted from the storage device 54 to the node 20-2 will be src_addr A3, dst_addr A2, src_port nvmeof-relay-port, and dst_port P3.

When the node 20-2 receives the TCP/IP message from the storage device 54 whose TCP/IP header includes src_addr A3, dst_addr A2, src_port nvmeof-relay-port, and dst_port P3, the header of the TCP/IP message transmitted from the node 20-2 to the node 20-1 will be src_addr A2, dst_addr A1, src_port nvmeof-relay-port, and dst_port P2.

The header of the TCP/IP message transmitted from the node 20-1 to the host 52 will be src_addr A1, dst_addr A0, src_port nvmeof-relay-port, and dst_port P1.

The header of the TCP/IP message transmitted from the host 52 to the node 20-3 includes src_addr A0, dst_addr A4, src_port P4, and dst_port nvmeof-relay-port. The source port number from which the host 52 transmits the message to the node 20-3 is P4.

The header of the TCP/IP message transmitted from the node 20-3 to the node 20-2 will be src_addr A4, dst_addr A2, src_port P5, and dst_port nvmeof-relay-port.

When the node 20-2 receives the TCP/IP message from the node 20-3 whose TCP/IP header includes src_addr A4, dst_addr A2, src_port P5, and dst_port nvmeof-relay-port, the header of the TCP/IP message transmitted from the node 20-2 to the storage device 54 will be src_addr A2, dst_addr A3, src_port P6, and dst_port nvmeof-relay-port.

When the storage device 54 receives the TCP/IP message from the node 20-2 whose TCP/IP header includes src_addr A2, dst_addr A3, src_port P6, and dst_port nvmeof-relay-port, the header of the TCP/IP message transmitted from the storage device 54 to the node 20-2 will be src_addr A3, dst_addr A2, src_port nvmeof-relay-port, and dst_port P6.

When the node 20-2 receives the TCP/IP message from the storage device 4328 whose TCP/IP header includes src_addr A3, dst_addr A2, src_port nvmeof-relay-port, and dst_port P6, the header of the TCP/IP message transmitted from the node 20-2 to the node 20-3 will be src_addr A2, dst_addr A4, src_port nvmeof-relay-port, and dst_port P5.

When the node 20-3 receives the TCP/IP message from the node 20-2 whose TCP/IP header includes src_addr A2, dst_addr A4, src_port nvmeof-relay-port, and dst_port P5, the header of the TCP/IP message transmitted from the node 20-3 to the host 52 will be src_addr A4, dst_addr A0, src_port nvmeof-relay-port, dst_port P4.

According to the third embodiment, in a case where at least one node 20 is arranged between the host 52 and the storage device 54, the host 52 controls whether to transmit a capsule indirectly to the storage device 54 via the at least one node 20 or to transmit a capsule directly to the storage device 54.

### Fourth Embodiment

The previous embodiments are related to an example in which the node 20 exists as a single node independent of the host 52 and the storage device 54. The following describes an example in which the node 20 is built into the host 52 or the storage device 54.

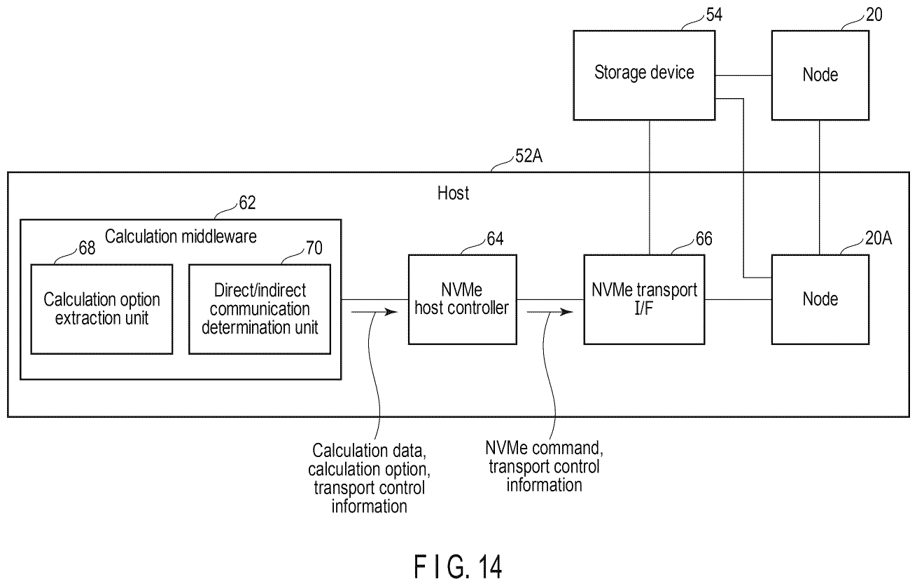

FIG. 14 illustrates an example of a configuration of a host 52A according to a fourth embodiment.

The host 52A is the host 52 shown in FIG. 10 with the node integrated. The node inside the host 52A is referred to as a node 20A. The NVMe transport I/F 66 is connected to the storage device 54 and the node 20A. The NVMe transport I/F 66 is physically connected to the node 20A via an internal bus (e.g., PCIe bus) of the host 52. The NVMe transport I/F 66 is connected to the storage device 54 via Ethernet, etc.

Although the NVMe transport I/F 66 is illustrated as a single interface, a plurality of physical interfaces may be provided for each physical medium. Although only one node 20A is illustrated in the host 52A, a plurality of nodes 20A may be integrated into the host 52A. The node 20A may be directly connected to the storage device 54, or it may be indirectly connected to the storage device 54 via at least one node 20 outside the host 52A.

A relay table of an accelerator 10 in the NVMe host controller 64 is the same as the relay table 42 shown in FIG. 4. However, in the fourth embodiment, an IP address is also assigned to the node 20A connected to the internal bus, and TCP/IP communication is performed within the host 52A. For example, TCP/IP communication is realized by communicating in a form such as TCP/IP over PCIe. In this case, the IP address to be assigned may be any address as long as it can ensure reachability and does not impede other communications.

On the other hand, the relay table 42 may be changed to control the connection to the NVMe transport I/F 66 by distinguishing that the connection to the NVMe transport I/F is an internal bus connection. Specifically, by changing the combination of an IP address and a port number to an ID (an identifier such as domain:bus:device.function) used to identify a PCIe device, the connected device can be uniquely identified. However, in a case where the node 20A is treated as a PCIe device, the transfer of host data corresponding to an NVMe command needs to be performed using DMA. Therefore, in a case where a previous hop node or a next hop node in the relay table 42 is the PCIe device, the NVMe command is transmitted and received and data is transferred by DMA on a PCIe bus, not by using NVMe/TCP. This function can be realized by extending the memory management unit 38 so that transmission and reception are performed over PCIe instead of TCP/IP, and through an interface connected to a local bus instead of a network I/F.

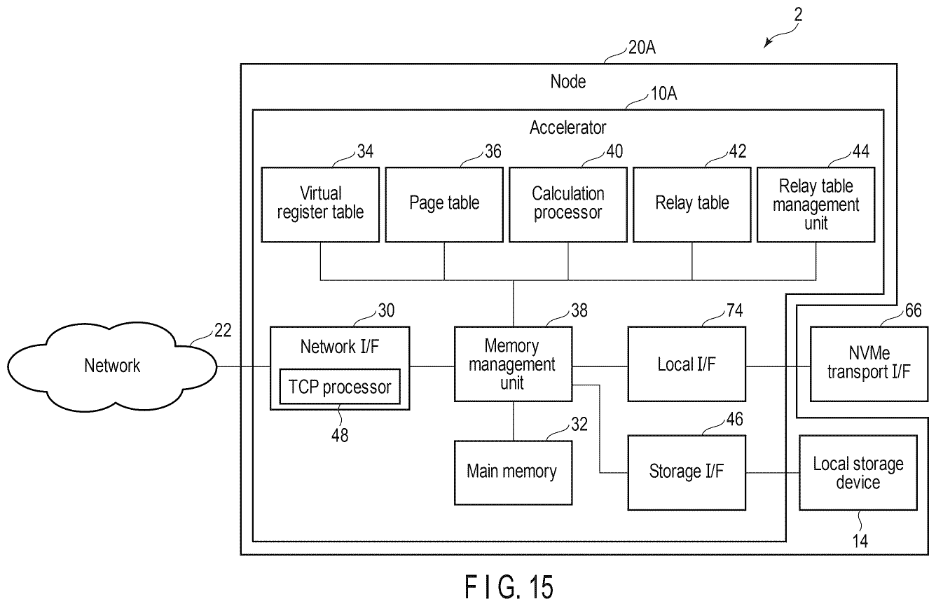

FIG. 15 illustrates an example of the node 20A according to the fourth embodiment.

The node 20A comprises a local I/F 74 in addition to the configuration of the node 20 shown in FIG. 1. The local I/F 74 is connected to the NVMe transport I/F 66 via an internal bus such as PCIe. The memory management unit 38 comprises a function that selects a method of transmitting and receiving commands and an interface (network I/F 30 and local I/F 74) to be used for transmission and reception, according to information in a previous hop designation part and a next hop designation part of the relay table 42.

In the case of notifying the node 20 or the storage device 54 that exists outside the host 52A of information about the built-in node 20A, in addition to the identifier of the device inside the host 52A, an IP address and a port number through which the host 52A communicates with the outside may be added to the message and notified. In a case where a plurality of nodes 20A are built into the host 52A, it is possible to use different IP addresses and different port numbers for notification for each node.

As described in the third embodiment, in a case where a branch point exists on a route and a node of a PCIe device is the branch point, a source PCIe device (e.g., host 52A) of an NVMe command to the node needs to transmit the NVMe command so as to uniquely identify the route beyond the branch point. As identifiers for identifying the route, any identifier on the PCIe bus included in the source PCIe device, any identifier on the PCIe bus included in a relay, or any identifier on the NVMe included in the relay (e.g., a namespace identifier) can be used. The identifier used can be anything as long as it is shared by the transmitting PCIe device and the relay when creating the relay table 42.

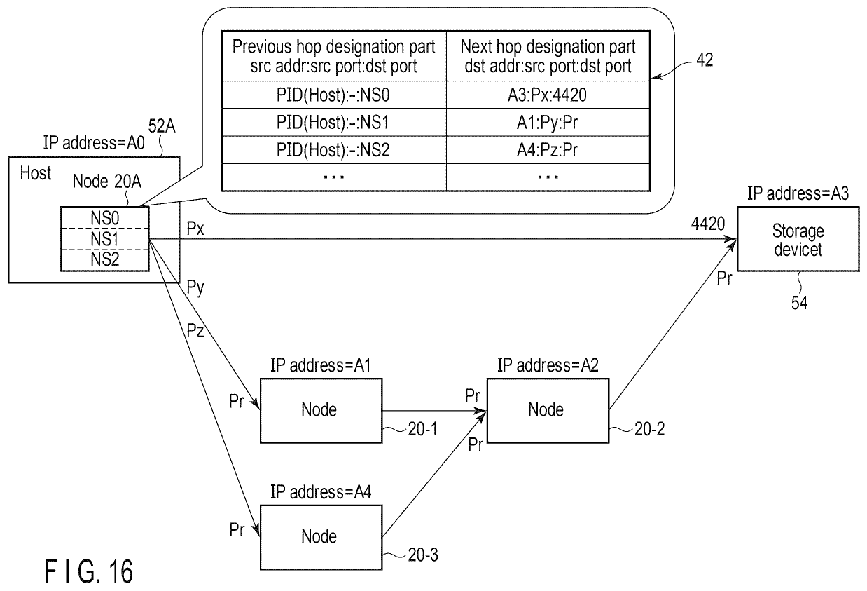

FIG. 16 illustrates an example of a network in a case where the namespace identifier is used as the identifier that identifies the route in the fourth embodiment.

The host 52A comprises the node 20A as the PCIe device. The node 20A is connected to the storage device 54 and nodes 20-1 and 20-3 using NVMe/TCP. Symbols Px, Py, and Pz attached to the edges of each node are source port numbers used by the node 20A when transmitting NVMe/TCP packets. Symbol Pr is a receiving port number used by the node 20 or the storage device 54. Number 4420 is a receiving port number used by the storage device 54 to receive an NVMe command without going through the node 20. The node 20A has three namespaces (the identifiers are NS0, NS1, and NS2, respectively). Although the drawing shows that the node 20A is divided into three parts, it is not actually divided. The transmission port number of the namespace with the identifier NS0 is Px. The transmission port number of the namespace with the identifier NS1 is Py. The transmission port number of the namespace with the identifier NS2 is Pz.

FIG. 16 also shows part of the relay table 42 used by the node 20A when relaying an NVMe command. PID(Host) in each row represents the ID of the PCIe device of the host 52 that transmits the NVMe command first. Since there is no information corresponding to a source port on the PCIe device, src_port“-” indicates that it is unused. A destination port has one of the namespace identifiers NS0 to NS2 that receives the NVMe command. For example, a first row entry of the relay table 42 indicates that in a case where an NVMe command is received in the namespace with the identifier NS0 and corresponding data is processed, a message is transmitted from the port Px to the port 4420 of a device with IP address A3 using NVMe/TCP.

In this way, in a case where the node 20A is integrated into the host 52A as a PCIe device, the branching of the route can be expressed using an identifier. Note that, although the case where the relay of the PCIe device is the branch point has been described, the same method can be applied to handle a case where the branch point is located after the relay of the PCIe device.

According to the fourth embodiment, the host 52A that integrates the node 20A is provided.

### Fifth Embodiment

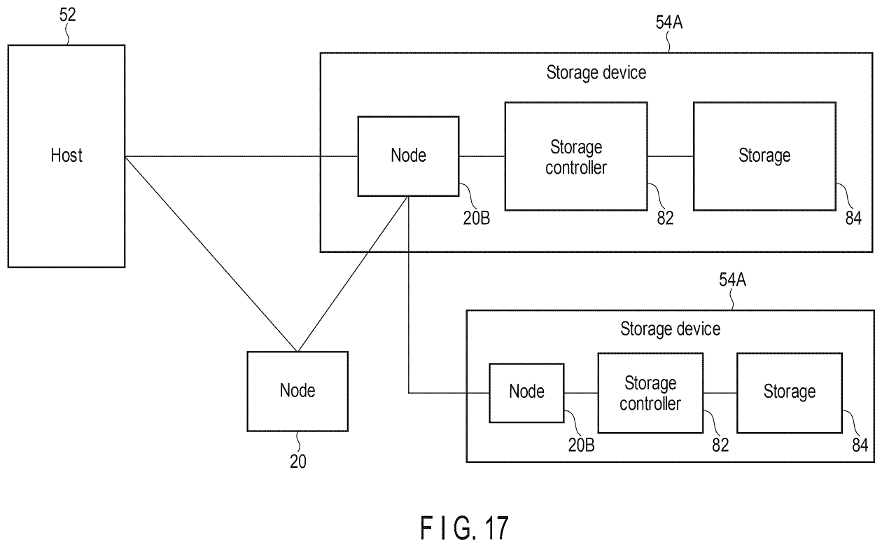

FIG. 17 illustrates an example of a network according to a fifth embodiment.

A storage device 54A comprises a storage 84, a storage controller 82, and a node 20B. The storage 84 is a storage medium. An example of the storage 84 is a NAND flash memory. The host 52 is connected to the node 20 via Ethernet, etc., and to the node 20B inside the storage device 54A. The node 20B is connected to the node 20. The connection method between the node 20B and the node 20 may be the same as the connection method between the host 52 and the storage device 54A (e.g., Ethernet), or may be a different method. The node 20B may be connected to nodes of other storage devices. The connection method between the storage devices may be the same as the connection method between the host 52 and the storage device 54A (e.g., Ethernet), or may be a different method. In the case of using a local storage device of the node 20B as the storage medium and the storage controller of the storage device 54A, the storage controller 82 and the storage 84 may not be necessary.

Changes to the relay table 42 according to the fifth embodiment are the same as those in the fourth embodiment. However, since the part of the storage device 54A that is connected to the outside is the node 20B, if an IP address and a port number are added when notifying the node 20B to the outside, the IP address and the port number that can be used by the node 20B may be added. The IP address and port number combination used for calculation processing of the node 20B may be different from the IP address and port number combination assigned to the node 20B for communication with the outside.

According to the fifth embodiment, the storage device 54A that integrates the node 20B is provided.

While certain embodiments have been described, these embodiments have been presented by way of example only, and are not intended to limit the scope of the inventions. Indeed, the novel devices and methods described herein may be embodied in a variety of other forms; furthermore, various omissions, substitutions, and changes in the form according to the embodiments described herein may be made without departing from the spirit of the inventions. The accompanying claims and their equivalents are intended to cover such forms or modification as would fall within the scope and spirit of the inventions.

What is claimed is:

1. A controller comprising:
a connection unit connectable to a first node and a second node using NVMe transport protocol, the connection unit configured to receive first data and an I/O command from the first node, and transmit second data, which is a result of calculation processing with respect to the first data, and the I/O command to the second node;
a memory configured to store the first data;
a virtual register table configured to store a virtual register number that accompanies the first data and is identified based on a calculation option that represents the calculation processing, in association with a virtual address of third data and a data size of the third data that are used to process a calculation instruction according to the calculation option;
a memory management unit configured to write the first data to the memory and update the virtual register table; and
a calculation processor configured to execute the calculation processing with respect to the first data by referring to the virtual register table.

2. The controller of claim 1, wherein
the first node is a host configured to transmit the I/O command and the first data accompanied by the calculation option, and
the second node is a storage device configured to receive the I/O command and the second data accompanied by the calculation option and store the second data.

3. The controller of claim 1, wherein
the first node is connectable to a host configured to transmit the I/O command and the first data accompanied by the calculation option, the first node comprising a first controller configured to execute same processing as the calculation processor, and
the second node is connectable to a storage device configured to receive the I/O command and the second data accompanied by the calculation option and store the second data, the second node comprising a second controller configured to execute same processing as the calculation processor.

4. The controller of claim 1, wherein
the controller is configured to store a relay table including records, each of the records comprising a pair of source information and destination information, and
the connection unit is configured to determine a destination of the second data by referring to the relay table.

5. The controller of claim 4, wherein
the source information comprises a source address, a source port number, and a destination port number,
the destination information comprises a destination address, a source port number, and a destination port number, and
the connection unit is configured to determine a destination of the second data based on the destination information of to a first record in the record, the first record corresponding to the source information including a source port number and a destination port number in the I/O command.

6. The controller of claim 5, further comprising:
a relay table management unit configured to create the relay table by setting a port number used to wait for connections from a first another node as the destination port number in the source information, and setting a port number used to connect to a second another node as the source port number in the destination information.

7. The controller of claim 5, further comprising:
a relay table management unit configured to
receive from an external device an IP address and a port number of the external device and an IP address and a port number of the second node, and
create the relay table by setting the received IP address and the received port number of the host as the source information, and setting the received IP address and the received port number of the second node as the destination information.

8. The controller of claim 1, wherein the virtual address comprises a page offset and a page number assigned to a page in which the second data is stored.

9. The controller of claim 1, wherein the calculation processing comprises secret calculation processing.

10. A host connectable to a storage device or a node using NVMe transport protocol, wherein
the host is configured to
execute an application program, create data and, in a case where the host causes the node to execute calculation processing with respect to the data, a calculation option configured to represent the calculation processing, and transmit a write command, the data, and the calculation option to the node, and
in a case where the host does not cause the node to execute the calculation processing with respect to the data when executing the application program, transmit the write command and the data to the storage device,
the storage device is configured to receive the write command and the data, and store the data, and
the node is configured to receive the write command, the data, and the calculation option, execute the calculation processing with respect to the data based on the calculation option, transmit the write command to the storage device, and transmit a result of the calculation processing as the data to the storage device.

11. The host of claim 10, wherein
the node is selected from a plurality of nodes, and
the host is configured to
set a destination port number of the data to a first port number that represents the storage device in a case where the calculation option is not created, and
set a destination port number of the data to a second port number that is common to the plurality of nodes in a case where the calculation option is created.

12. The host of claim 10, wherein the calculation processing comprises secret calculation processing.

13. A communication method receiving first data and an I/O command from a first node using NVMe transport protocol, and transmitting second data, which is a result of calculation processing with respect to the first data, and the I/O command to the second node using NVMe transport protocol comprising:
writing the first data to a memory;
writing a virtual register number that accompanies the first data and is identified based on a calculation option that represents the calculation processing to a virtual register table, in association with a virtual address of third data and a data size of the third data that are used to process a calculation instruction according to the calculation option;
writing the first data to a memory and updating the virtual register table; and
executing the calculation processing with respect to the first data by referring to the virtual register table.

14. The communication method of claim 13, wherein
the first node is a host configured to transmit the I/O command and the first data accompanied by the calculation option, and
the second node is a storage device configured to receive the I/O command and the second data accompanied by the calculation option and store the second data.

15. The communication method of claim 13, further comprising:
storing a relay table including records, each of the records comprising a pair of source information and destination information; and
determining a destination of the second data by referring to the relay table.

16. The communication method of claim 15, wherein
the source information comprises a source address, a source port number, and a destination port number,
the destination information comprises a destination address, a source port number, and a destination port number, and
the determining comprises determining a destination of the second data based on the destination information of a first record in the record, the first record corresponding to the source information including a source port number and a destination port number in the I/O command.

17. The communication method of claim 13, wherein the virtual address comprises a page offset and a page number assigned to a page in which the second data is stored.

18. The communication method of claim 13, wherein the calculation processing comprises secret calculation processing.
